(19) United States
(12) Patent Application Publication
(10) Pub. No.: US 2009/0174729 A1
(43) Pub. Date: Jul. 9, 2009

(54) IMAGE DISPLAY DEVICE AND CONTROL METHOD THEREOF

(75) Inventor: Kazuhiko MATSUMOTO, Tokyo (JP)

Correspondence Address: YOUNG & THOMPSON, 209 Madison Street, Suite 500, ALEXANDRIA, VA, 22314, US

(73) Assignee: ZIOSOFT, INC., Tokyo (JP)

(21) Appl. No.: 12/348,140

(22) Filed: Jan. 2, 2009

(30) Foreign Application Priority Data
Jan. 9, 2008 (JP) 2008-002365

(51) Int. Cl. G09G 5/00

(52) U.S. Cl. 345/619

(57) ABSTRACT

One of the object of the present invention is to provide medical image display device and etc. that visualizes at least one volume data using a Raycast method, are provided with:a color acquisition function for acquiring color from voxel value, wherein at least two or more color acquisition functions are corresponding to at least one of the volume data; a color acquisition function calculating feature for calculating a new color acquisition function that corresponds to at least one of the color acquisition functions; and a visualization feature for visualizing the at least one volume data by the Raycast method using two or more color acquisition functions and, at least one of the color acquisition function is the new color acquisition function.

### BACKGROUND OF THE INVENTION

1. Field of the Invention

The present invention relates to an image display device and a display method thereof that make it possible to view volume data.

2. Description of the Related Art

With the advancement of image processing technology, the emergence of CT (Computer Tomography) or MRI (Magnetic Resonance Imaging) that enables direct observation of internal structure and tissue of the body has brought about innovations in the medical field, and tomographic images of the body are now widely used in medical diagnosis. Furthermore, in recent years, visualizing technology enables viewing complex three-dimensional structures inside the body that are difficult to study via standard slice images. For example, volume rendering that directly draws images of three-dimensional structures from three-dimensional data (volume data) of a body that are obtained from CT, is being widely used in medical diagnosis.

MPR (Multi Planar Reconstruction) is a well known volume rendering method which displays arbitrary cross sections of volume data.

The Raycast method is another well known volume rendering method. The Raycast method is a method in which virtual rays are cast onto an object, and an image is built on a project plane by reflected light from the inside of the object.

The images obtained by the Raycast method differ depending on function settings for the voxel values of the volume data, opacity settings, color settings such as hue, color saturation, brightness (value) and the like for the output color, or mask settings.

Particularly in the medical field, information of positional relationships (for example, anteroposterior relationship, interaction, etc.) within plurality of objects is important.

For example, when viewing the state of an affected region, an understanding of the affected region can be obtained from the positional relationship between the affected region and the surrounding tissue or structure. Therefore, it is extremely important that the shapes of the plurality of objects of interest to be clearly reproduced simultaneously in one image. This importance is evident from the aspect that medical images serve a very large role in the course of treatment by a practitioner when performing an operation (for example, serves as an aid in deciding where to use the scalpel and how to proceed with the operation), as well as have great significance in the explanation (explanation for informed consent) that is provided to patients for which an operation will be performed.

Therefore, volume data are drawn distinguished between organs and affected regions. More specifically, each target are drawn by different opacity settings and color settings such as hue, saturation and brightness (value) for organs having different voxel values such as CT values. Additionally, in the case that two organs have same voxel values, each organs region are segmented, and each regions are drawn by different opacity settings and color settings such as hue, saturation and brightness (value) for each region. Moreover, volume data can be drawn by using combinations of the above.

Furthermore, by preparing a plurality of volume data having different imaging conditions, it is possible to distinguish and draw a plurality of blood vessels and organs that are fed by those blood vessels. In addition, there is a method called multi-modality fusion that uses a plurality volume data that are obtained from different imaging devices (for example, refer to Japanese Patent laid-open Application 2003-109030, and published application US 2007-98299A1).

In the conventional Raycast method described above, there are problems in user operation when distinguishing volume data. In case drawing images for each organ or affected region of interest is complex, it is difficult to select suitable images (there are cases in which it is possible to make suitable selections if a proper amount of time is used), it is difficult to intuitively identify the displayed images, and there are limits to the amount of data that can be processed. Particularly, it is difficult to distinguish volume data and draw images for each extracted region. The reason for that is that it is necessary to create different LUT coefficients for each region. Also, there is a problem in that the opacity settings, and color settings such as hue, saturation and brightness (value) may vary due to user subjection.

### SUMMARY OF THE INVENTION

Taking the aforementioned problems into consideration, the object of the present invention is to provide an image display device and control method thereof that make it possible for a user to intuitively and easily distinguish and identify a plurality of images (locations of objects to be displayed) that are desired for observation by using an input device such as a pointing device to handle images that are displayed on a medical image display device, even though the user (operator such as a physician, etc.) may not be proficient in the operation of the medical image display device.

The present invention recited in Claim 1 for solving the problems is directed to a medical image display device that visualizes at least one volume data using a Raycast method, that is provided withg: a color acquisition function for acquiring color from voxel value, wherein at least two or more color acquisition functions are corresponding to at least one of the volume data; a color acquisition function calculating feature for calculating a new color acquisition function that corresponds to at least one of the color acquisition functions; and a visualization feature for visualizing the at least one volume data by the Raycast method using two or more color acquisition functions and, at least one of the color acquisition function is the new color acquisition function.

With the present invention, when using the Raycast method to visualize volume data that include a plurality of observation sites, even though color settings that were suitable when observing each observation site independently are no longer suitable when observing the plurality of observation sites at the same time because the color settings for those plurality of observation sites are similar to each other, visualization is enabled by using a new color acquisition function to assign other colors, so it becomes easy for the user to distinguish a plurality of sites that are displayed in an image.

Furthermore, since the calculation for finding a new color acquisition function is performed automatically and not according to the judgment of the user, it is possible for a user (operator) that must process many medical images in one day to eliminate the time required to determine how to change the colors one by one by way of a user interface, and thus it becomes possible to ease the burden of labor on the user and to greatly reduce judgment and operation error. Moreover, even when images are handled by a plurality of users, standardized processing can be performed, so it is possible to improve the objectivity of the resulting image.

The present invention recited in Claim 2 for solving the problems is directed to the medical image display device of claim 1, wherein the color acquisition function calculating feature performs calculation so that the new color acquisition function to differ from other color acquisition functions so that at least one of hue, saturation and value of the color assigned by the color acquisition functions differs from each other, when the colors assigned by the two or more color acquisition functions are similar to each other.

With the present invention, the color acquisition means uses a color function to independently visualize of a site or part of a site of one organ or the like, so there are cases in which the same family (similar) of color is used even though the site is different, however, the color acquisition calculation means automatically assigns colors so that differing sites (or each part of the same site) are easily viewed by the user, so it becomes easier for the user to view screens on which different sites or parts of the same site are displayed at the same time, and thus it becomes possible for the user to perform treatment based on good judgment, and to properly explain pathological changes to a patient.

The calculation to find new color acquisition functions is performed automatically by the color acquisition calculation means without judgment by the user, so it is possible for a user (operator) that must process many medical images in one day to eliminate the time required to determine how to change the colors one by one by way of a user interface, and thus it becomes possible to ease the burden of labor on the user and to greatly reduce judgment and operation error.

The present invention recited in Claim 3 for solving the problems is directed to the medical image display device of claim 1, wherein the color acquisition function calculating feature calculates the new color acquisition functions that correspond to other color acquisition functions that are not set in advance by a user in the case when there are the color acquisition functions that are set in advance by the user.

With the present invention, when the user sets in advance the color that will be assigned by the color acquisition function when observing each of the observation sites separately (when the user sets the color of the image to be viewed to a desired color), the instruction from the user is valued, and the color that was specified by the user to be assigned by the color acquisition function when observing each of the observation sites separately is also used when observing a plurality of observation sites at the same time, then by newly calculating a color acquisition function to be used in the visualization of other observation sites, the user is able to obtain the anticipated result, thus it is not necessary for the user to set a desired color again, so the amount of user operation is reduced, and there is no extra burden or work placed on the user (becomes a user friendly design).

The present invention recited in Claim 4 for solving the problems is directed to the medical image display device of claim 3, wherein the color acquisition function calculating feature performs calculation so that the new color acquisition function to differ from the color acquisition functions that are set in advance by the user, so that at least one of the hue, saturation and value of the color assigned by the color acquisition functions differ from each other.

With this invention, even when the user sets in advance the color that will be assigned by the color acquisition function when observing each of the observation sites separately (when the user sets the color of an image to be displayed on the screen to a desired color), different sites or other parts of the same site are displayed so that the colors assigned by the color acquisition functions used in enabling the visualization of other observation sites are different colors than the color set in advance by the user (colors of which at least one of the hue, saturation and value differ) are displayed, so the user is able to obtain the anticipated result, and it is possible to provide an image that is easy for the user to view and that does not apply a burden on the user of having to operate a user interface.

The present invention recited in Claim 5 for solving the problems is directed to the medical image display device of claim 1, is further provided with: a mask acquisition feature for acquiring masks that correspond to each of the color acquisition functions; wherein the visualization feature uses the masks to visualize the at least one volume data by the Raycast method

With the present invention, when extracting and performing calculation for the site of an organ or the part of one organ (example: tumor tissue in a lung) that is to be displayed, a mask (means of making only a specified region of the volume data the object of drawing, or means of making all regions except a specified regions the object of drawing) is used, so it becomes possible to accurately display a specified region of a site or part of the same site (not display images of other regions that are not desired).

This is particularly effective when it is desired to separate and draw a plurality of observation sites when there is a range of overlapping CT values for the observation sites. In this case, skillfully creating one color acquisition means is not sufficient, so this invention has the advantage of having a plurality of color acquisition means.

The present invention recited in Claim 6 for solving the problems is directed to the medical image display device of claim 1, wherein the color acquisition function is implemented by a piecewise function.

The present invention recited in Claim 7 for solving the problems is directed to the medical image display device of claim 6, wherein the piecewise function of the color acquisition function is implemented by a Look Up Table (LUT).

With the present invention, instead of outputting the numerical value to be found by calculating the given numerical value, the piecewise function simply selects the given numerical value from a preset table, so it is possible to achieve a high-speed and flexible continuous function.

The present invention recited in Claim 9 for solving the problems is directed to the control method for a medical image display device of claim 8, wherein the color acquisition function calculation step performs calculation so that the new color acquisition function to differ from other color acquisition functions so that at least one of hue, saturation and value of the color assigned by the color acquisition functions differs from each other, when the colors assigned by the two or more color acquisition functions are similar to each.

The present invention recited in Claim 10 for solving the problems is directed to the control method for a medical image display device of claim 8, wherein the color acquisition function calculation step calculates the new color acquisition functions that correspond to other color acquisition functions that are not set in advance by a e user in the case when there are the color acquisition functions that are set in advance by the user.

The present invention recited in Claim 11 for solving the problems is directed to the control method for a medical image display device of claim 10, wherein the color acquisition function calculation step performs calculation so that the new color acquisition function to differ from the color acquisition functions that are set in advance by the user, so that at least one of the hue, saturation and value of the color assigned by the color acquisition functions.

The present invention recited in Claim 12 for solving the problems is directed to the control method for a medical image display device of claim 8, is further provided with: a mask acquisition step of acquiring masks that correspond to each of the color acquisition functions; wherein the visualization step uses the masks to visualize the at least one volume data by the Raycast method.

The present invention recited in Claim 13 for solving the problems is directed to the control method for a medical image display device of claim 8, wherein the color acquisition function is implemented by a piecewise function.

The present invention recited in Claim 14 for solving the problems is directed to the control method for a medical image display device of claim 13, wherein the piecewise function of the color acquisition function is implemented by a Look Up Table (LUT).

With the present invention, when using the Raycast method to visualize volume data that include a plurality of observation sites, even though color settings that were suitable when observing each observation site independently are no longer suitable when observing the plurality of observation sites at the same time because the color settings for those plurality of observation sites are similar to each other, visualization is enabled by using a new color acquisition function to assign other colors, so it becomes easy for the user to distinguish a plurality of sites that are displayed in an image.

Furthermore, since the calculation for finding a new color acquisition function is performed automatically and not according to the judgment of the user, it is possible for a user (operator) that must process many medical images in one day to eliminate the time required to determine how to change the colors one by one by way of a user interface, and thus it becomes possible to ease the burden of labor on the user and to greatly reduce judgment and operation error. Moreover, even when images are handled by a plurality of users, standardized processing can be performed, so it is possible to improve the objectivity of the resulting image.

With the present invention, the color acquisition means uses a color function to independently visualize a site or part of a site of one organ or the like, so there are cases in which the same family (similar) of color is used even though the site is different, however, the color acquisition calculation means automatically assigns colors so that differing sites (or each part of the same site) are easily viewed by the user, so it becomes easier for the user to view screens on which different sites or parts of the same site are displayed at the same time, and thus it becomes possible for the user to perform treatment based on good judgment, and to properly explain pathological changes to a patient.

The calculation to find new color acquisition functions is performed automatically by the color acquisition calculation means without judgment by the user, so it is possible for a user (operator) that must process many medical images in one day to eliminate the time required to determine how to change the colors one by one by way of a user interface, and thus it becomes possible to ease the burden of labor on the user and to greatly reduce judgment and operation error.

With the present invention, when the user sets in advance the color that will be assigned by the color acquisition function when observing each of the observation sites separately (when the user sets the color of the image to be viewed to a desired color), the instruction from the user is valued, and the color that was specified by the user to be assigned by the color acquisition function when observing each of the observation sites separately is also used when observing a plurality of observation sites at the same time, then by newly calculating a color acquisition function to be used in the visualization of other observation sites, the user is able to obtain the anticipated result, thus it is not necessary for the user to set a desired color again, so the amount of user operation is reduced, and there is no extra burden or work placed on the user (becomes a user friendly design).

With this invention, even when the user sets in advance the color that will be assigned by the color acquisition function when observing each of the observation sites separately (when the user sets the color of an image to be displayed on the screen to a desired color), different sites or other parts of the same site are displayed so that the colors assigned by the color acquisition functions used in enabling the visualization of other observation sites are different colors than the color set in advance by the user (colors of which at least one of the hue, saturation and value differ) are displayed, so the user is able to obtain the anticipated result, and it is possible to provide an image that is easy for the user to view and that does not burden the user with the operation of a user interface.

With the present invention, when extracting and performing calculation for the site of an organ or the part of one organ (example: tumor tissue in a lung) that is to be displayed, a mask (means of making only a specified region of the volume data the object of drawing, or means of making all regions except a specified regions the object of drawing) is used, so it becomes possible to accurately display a specified region of a site or part of the same site (not display images of other regions that are not desired).

This is particularly effective when it is desired to separate and draw a plurality of observation sites when there is a range of overlapping CT values for the observation sites. In this case, skillfully creating one color acquisition means is not sufficient, so this invention has the advantage of having a plurality of color acquisition means.

With the present invention, instead of outputting the numerical value to be found by calculating the given numerical value, the piecewise function simply selects the given numerical value from a preset table, so it is possible to achieve a high-speed and flexible continuous function.

Therefore, it is possible to greatly improve the operability of the user interface, and achieve a more effective user interface.

### BRIEF DESCRIPTION OF THE DRAWINGS

FIG. 1A is a drawing showing an example of the system configuration of an embodiment of the invention, and FIG. 1B is a drawing showing the hardware configuration of that embodiment.

FIG. 2 is a drawing showing an example of an imaging system of an embodiment of the invention.

FIG. 3 is a drawing that explains volume data and voxels.

FIG. 4 is a drawing that explains the relationship between voxel value and opacity.

FIG. 5 is a drawing that explains volume rendering.

FIG. 6 is a flowchart showing an example of the operation of the Raycast method in an embodiment of the invention.

FIG. 7 is a drawing showing an example of a conventional screen.

FIG. 8 is a drawing showing an example of a screen of this invention.

FIG. 9 is a flowchart showing an example of the operation of a first embodiment of the invention.

FIG. 10 is a drawing that explains the method of creating a plurality of LUTs in a first embodiment of the invention.

FIG. 11 is a drawing that explains the method of creating a plurality of LUTs in a first embodiment of the invention.

FIG. 12 is a flowchart showing an example of the operation of a first embodiment of the invention.

FIG. 13 is a drawing showing a screen of a second embodiment of the invention that shows part of a structure (site).

FIG. 14 is a drawing showing a screen of a second embodiment of the invention that shows part of a structure (site).

FIG. 15 is a drawing showing a screen of a second embodiment of the invention that shows part of a structure (site).

FIG. 16 is a drawing showing a screen of a second embodiment of the invention on which structures (sites) are drawn simultaneously.

### DESCRIPTION OF THE PREFERRED EMBODIMENTS

The preferred embodiments of the invention will be explained below based on the supplied drawings.

### 1. Example of System Configuration

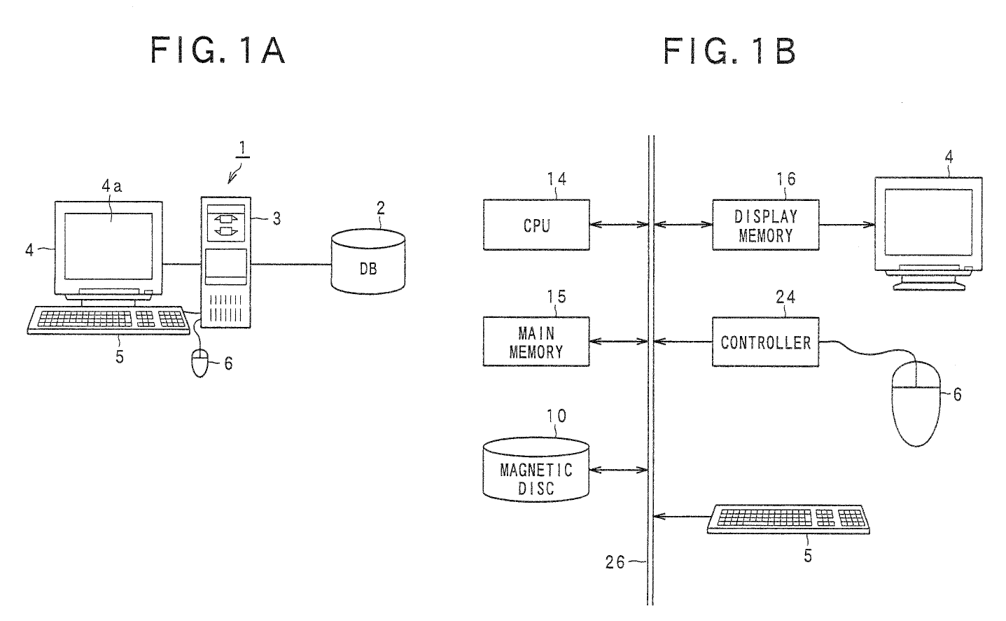

FIG. 1A is a block diagram showing an example (an embodiment) of the system configuration of the present invention.

As shown in FIG. 1A, an image display device 1 reads, for example, CT image data, which were taken by a CT (Computerized Tomography) imaging device, from a database 2, then creates and displays various images for medical diagnosis. In this embodiment, an example of using CT image data is explained, however, the invention is not limited to this. That is, the image data that are used is not limited to CT image data, and could be any kind of data obtained from a medical image-processing device such as MRI (Magnetic Resonance Imaging) data, or could be a combination of kinds of data or could be processed data.

The image display device 1 is provided with comprises: a computational device (computer, workstation, personal computer) 3, a monitor 4, and an input device such as a keyboard 5 and a mouse 6. The computational device 3 is connected to the database 2.

FIG. 1B is a block diagram that shows an example of the hardware configuration of the image-display device 1 that employs the method of this invention. As shown in FIG. 1B, this image-display device 1 is mainly provided with: a magnetic disc 10, main memory 15, a central processing unit (CPU) 14 that functions as an opacity piecewise function operation means, color acquisition means, new color acquisition means, visualization means and mask acquisition means, a display memory 16, a monitor 4 as a display means, a keyboard 5, a mouse 6 as a pointing device for inputting various operation control instructions, position instructions, and menu selection instructions, a mouse controller 24, and a common bus 26 that connects all of these components together.

The magnetic disc 10 stores a plurality of tomographic images, and image-creation programs, and as necessary, stores tomographic images that are read from the database 2 that is located outside of the common bus 26. The main memory 15 stores the control programs for the device, as well as comprises regions for computation. The CPU 14 reads a plurality of tomographic images and various programs, and using the main memory 15 creates a pseudo three-dimensional images or cross-sectional images to be displayed, then sends image data for that created image to the display memory 16 and displays the image on the monitor 4.

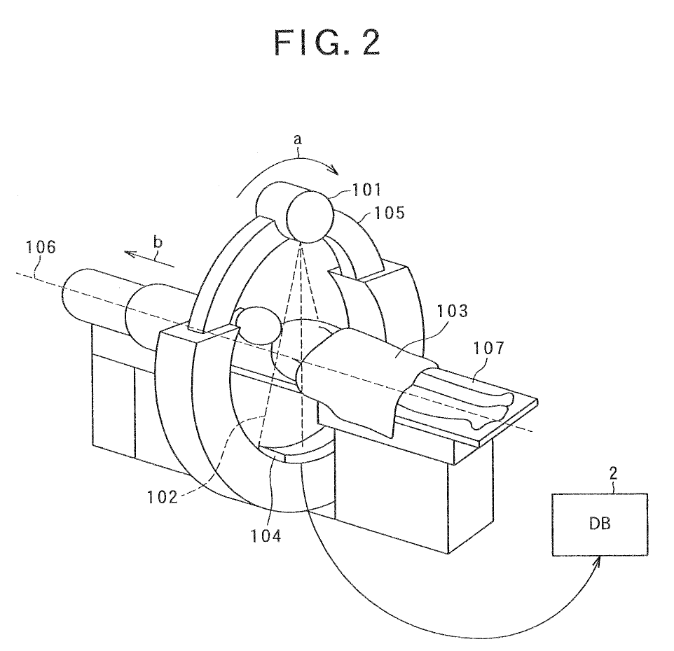

Next, FIG. 2 will be used to explain the data stored in the database 2. FIG. 2 shows a computer tomographic (CT) imaging device that is used in the image-processing method of an embodiment of the invention. The computer tomographic imaging device makes it possible to visualize tissues or structures (sites) in the body being examined. As shown in FIG. 2, an X-ray source 101 emits a pyramid-shaped X-ray beam flux 102 having edge beams as shown by the dotted lines in the figure. An X-ray beam flux 102 is irradiated to an X-ray detector 104, for example, passing through a patient 103 being examined. In this embodiment of the invention, the X-ray source 101 and an X-ray detector 104 are located inside a ring-shaped gantry 105 so that they face each other. The ring-shaped gantry 105 is supported by a supporting structure (not shown in the figure) so that it can rotate (see the direction of arrow ‘a’) with respect to the system axis line 106 that passes through the center of the gantry 105.

In this embodiment of the invention, a patient 103 lays on top of a table 107 through which X-rays pass. This table 107 is supported by a support structure (not shown in the figure) so that it can move along the system axis 106 (see arrow ‘b’).

The X-ray source 101 and X-ray detector 104 can rotate around the system axis 106, and form a measurement system that is capable of moving along the system axis line 106 relative to the patient, so the patient 103 can be irradiated at various imaging angles and positions with respect to the system axis line 106. The output signal from the X-ray detector 104 that is generated when doing this is supplied to a volume-data-generation unit 111 and converted to volume data.

In the case of sequence scanning, scanning is performed for each tomographic layer of the patient. When doing this, the X-ray source 101 and X-ray detector 104 rotate around the patient 103 around system axis line 106, and the measurement system that includes the X-ray source 101 and X-ray detector 104 takes a plurality of images for scanning two-dimensional tomographic layers of the patient 103. Tomographic images that display the scanned tomographic layers are reconstructed from the measurement values that are acquired at this time. During scanning of phase continuous tomographic layers, the patient 103 is moved along the system axis line 106 in that case. This process is repeated until all of the related tomographic layers are acquired.

On the other hand, during spiral scanning, the measurement system that includes the X-ray source 101 and X-ray detector 104 rotates around the system axis line 106, and the table 107 moves continuously in the direction indicated by arrow b. In other words, the measurement system that includes the X-ray source 101 and X-ray detector 104 continuously moves in a spiral path relative to the patient 103 until data from all of the regions of interest of the patient 103 have been obtained. In the case of this embodiment, the computer tomographic imaging device that is shown in FIG. 2 supplies a signal for a plurality of continuous tomographic layers located within the diagnostic range of the patient 103 to the database 2.

### 2. Explanation of the Voxels of the Volume Data

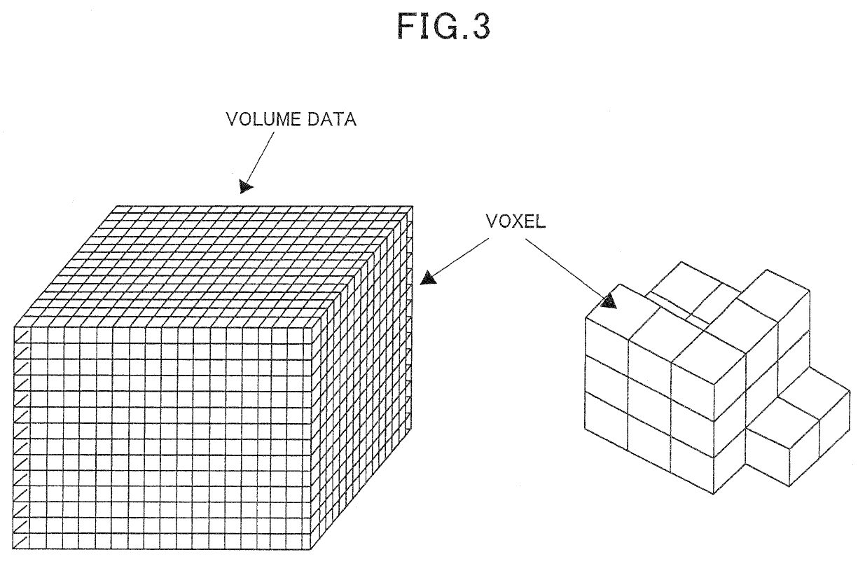

As shown in FIG. 3, volume data, which are image data that are three-dimensional (or three-dimensional plus time) collection of Voxels, which are density values assigned to the three-dimensional lattice points. In this embodiment, the values of the picture elements of the CT image data, or in other words the CT values, are taken to be the density values of the Voxel data VD. It is also possible to use the values of PET data to be the density values of the Voxel data VD. In medical images, Voxels are often represented by scalar values (monochrome) having values from −2048 to 2047.

CT image data are data obtained from acquiring tomographic images of the body of a patient, and one image is a two-dimensional tomographic image of the observed object such as bones, blood vessels, organs or the like, and since the images are obtained from a plurality of adjacent slices, all of these images together can be said to form three-dimensional image data (volume data). Therefore, hereafter, CT image data will refer to three-dimensional image data that include a plurality of slices.

The CT values, which are the picture element values of the CT image data, have values that correspond to the composition of the tissue or structure (bone, blood, fat, etc.) of the body being examined. The CT values are X-ray linear attenuation coefficients of tissue or structure that is represented with water as a reference, and from the CT values it is possible to determine the type of tissue, lesion, etc (the unit used is HU (Hounsfield Unit). The CT values are standardized by the X-ray linear attenuation coefficients of water and air, where the CT value of water is taken to be 0, and the CT value of air is taken to be −1000. In this case, the CT value for fat is about −120 to −100, the CT value for normal tissue is about 0 to 120, and the CT value for bone is approximately 1000. CT image data also have coordinate data for the tomographic images (slice images) of the body undergoing CT scanning by the CT imaging device, and the positional relationship between different tissues in the direction of the line of sight (depth direction) can be determined from the coordinate data. In other words, the Voxel data VD comprises Voxel values (CT values in the case of a CT device) and coordinate data.

### 3. Explanation of the Relationship Between Voxel Value and Opacity

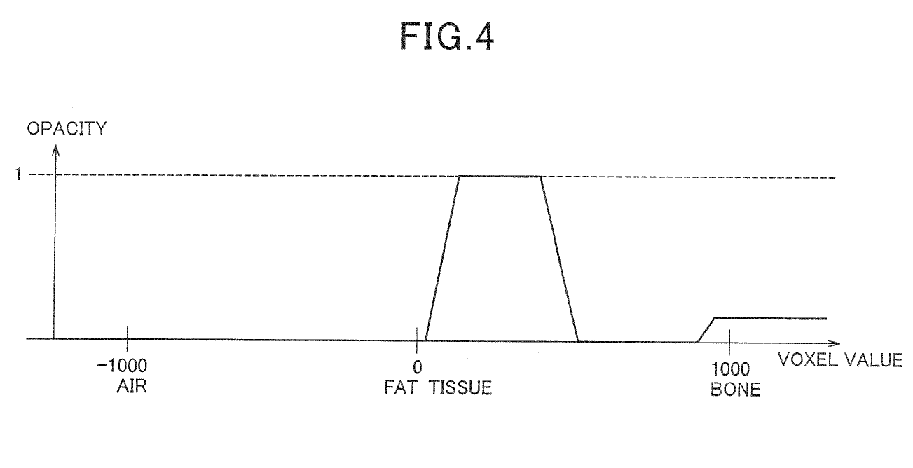

FIG. 4 is a drawing showing the relationship between the Voxel value and opacity in the Raycast method. In the Raycast method, by setting the opacities according to the CT values when drawing tissue, tissue for which the opacity has been set is drawn. When doing this, a piecewise function can be used as the function for converting the Voxel values to opacity (the relationship between the Voxel value and opacity will be called the opacity piecewise function). In FIG. 4, the Voxel value is shown along the horizontal axis (in this case, this is the CT value).

In FIG. 4, an opacity is set for each site. The opacity for normal tissue (Voxel value of 0 to 120) is set to 1 (an opacity value of 1 indicates that the object is opaque (all light is reflected)), the opacity for bone (Voxel value of approximately 1000) is set to an intermediate value of 0 to 1 (an opacity value of 0 to 1 indicates that the object is semi transparent (part of the incident light is reflected, the other part passes through the object), and the opacity of sites of other tissue is set to 0 (an opacity of 0 indicates that the object is transparent (all incident light passes through the object).

Therefore, in FIG. 4, tissue is drawn opaque, and bone is drawn semi transparent. The method used by the user to visualize a desired site according to the correlation between the opacity value and Voxel value will be explained in further detail next.

As was described above, by making the opacity value of the range of Voxel values that include the organ to be checked close to 1, and making the opacity value of the range of Voxel values that include organs that do not need to be displayed as an image close to 0, it is possible for the user to clearly observe an image of a desired site such as an organ or the like.

### 4. Explanation of the Raycast Method

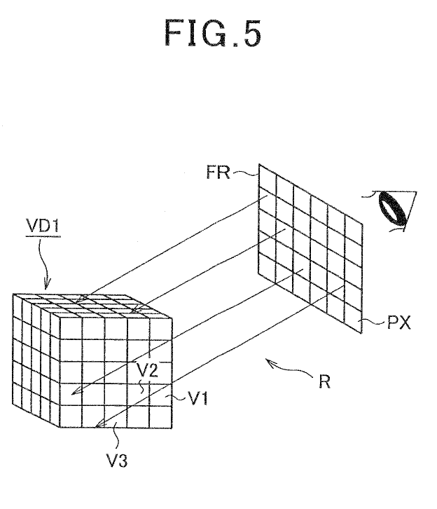

Next, the Raycast method will be explained. The Raycast method is one method of performing volume rendering. As shown in FIG. 5, the Raycast method takes into consideration the virtual path of light from the observed side (frame FR side), where light rays from the pixels PX of the frame FR (virtual light rays R) are projected, and every time the light advances a set distance, the reflected light at those positions is measured (in FIG. 5, the code ‘V1, V2, V3, . . . ’ corresponds to the Voxels at each of the positions).

When one virtual ray of light R is irradiated onto the Voxel data from the direction of the line of sight, the virtual ray of light R hits the first Voxel data VD1, where part of the light ray is reflected and remaining light passes through the Voxel of the first Voxel data VD1 and advances. The absorbed light and reflected light at each Voxel is calculated discretely, and the pixel values (picture element values) of the image that is projected onto the frame FR are found and a two-dimensional image is created by totaling the amount of reflected light.

In FIG. 5, when the projected position Xn (current position of the arrived virtual ray of light) is not on a grid, first, interpolation processing is performed from the Voxel values of the Voxels around that projected position Xn (current position of the arrived virtual ray of light), and the Voxel value Dn at that position is calculated.

A Voxel value for which interpolation processing is performed is called an interpolated Voxel value. One example of the computation for obtaining the interpolated Voxel value is gained by computing the weighted average from the nearby Voxel values.

In FIG. 5, when light I becomes incident on the Voxel, it is desired that the gradient at the projection position X be found. This is because the gradient is used for adding shadow to the surface of the organ or the like that is included in the volume data before drawing the image. A few of the Voxel values near the projection position are used in computing the gradient G of the projection position Xn.

Next, the characteristic parameters (hereafter, referred to as optical parameters P) of the light are determined.

The optical parameters P are information that express the independent optical characteristics such as opacity (opacity value) α n and a shading coefficient βn as opacity information, and color γn as color information. Here, the opacity α n is expressed by a numerical value that satisfies the relationship 0≦αn≦1, and the value (1−αn) indicates the transparency. An opacity value αn=1 corresponds to the object being opaque, an opacity value αn=0 corresponds to the object being transparent, and an opacity value 0<αn<1 corresponds to the object being semi transparent. As described above, the opacity αn is correlated beforehand with each Voxel value, and the opacity αn is obtained from the Voxel values based on that correlation information. For example, as described above, when it is desired that a volume rendering image of bone be obtained, by correlating an opacity value of ‘1’ with the Voxel value that corresponds to bone, and correlating an opacity value of ‘0’ with other Voxel values, it is possible to display bone. Conversion that leads from one value to another value in this way is generalized by the piecewise function, and in actual practice, a LUT (Look Up Table) function is often used.

The shading coefficient βn is a parameter that indicates the unevenness (shadows) on the surface of the Voxel data, and uses the inner product of the gradient G and direction vector that the light travels in.

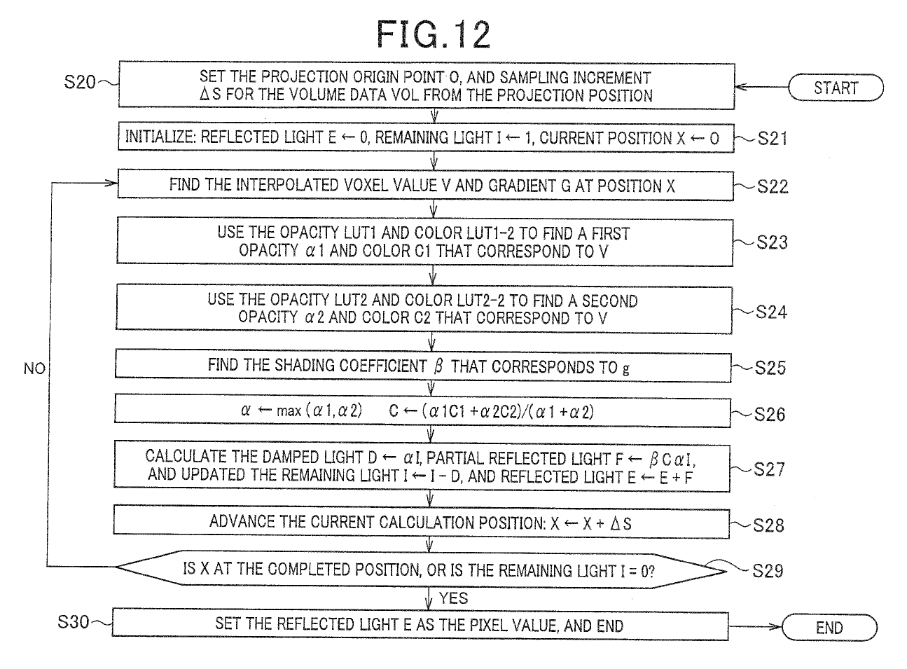

Moreover, similar to the opacity αn, the color γn can be expressed by the piecewise function, and expresses the structure or tissue information of the Voxel data, or in other words, uses color to express information indicating whether the Voxel data are for bone, blood, an internal organ or a tumor. In this way, by assigning virtual color to only Voxel values of contrast information that does not include color information, it is possible to provide images that are easy for the user to identify. Moreover, when it is desired to give objectivity priority, color information is not assigned and only white is used in drawing an image. In addition, as will be described later using FIG. 12, it is possible to draw an image of a structure or tissue by extracting regions with an organ extraction algorithm, then taking these extracted regions as the regions to be drawn, and using a different piecewise function for each region to be drawn.

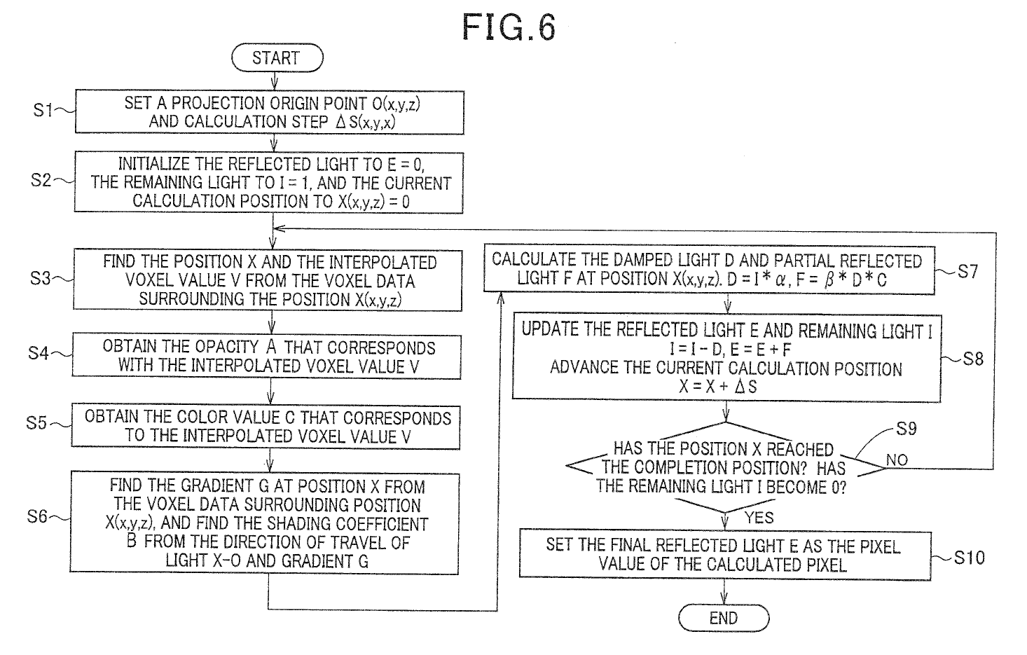

The calculation method of the Raycast method will be explained using FIG. 6.

In Step S1, the origin of projection O(x, y, z), and calculation steps ΔS(x, y, z) in the direction of travel of the light from the origin of projection are set.

In step S2, the reflected light E, the remaining light I, and the current calculation position X are initially set. That is, since light is not reflected at the projection origin point, the reflected light E=0, and at the projection origin point, since there is no reduced light, the remaining light becomes ‘1’ (normalized by ‘1’). Moreover, the current calculation position X is taken to be the projection origin point, and that current calculation position X is set and initialized to X=0.

In step S3, the position to where the calculation steps ΔS have advanced from the projection origin point is taken to be the current calculation position X, and the interpolated Voxel value V for that current calculation position X is found from the surrounding Voxel data (surrounding Voxel values). This is because, the position where the Voxel values are arranged in a grid shape, and since the light freely passes through the vertices of this grid shape, the current calculation position X is not necessarily located at a vertex of the grid found from CT or the like. The interpolated Voxel value V can be obtained by calculating the average value or weighted average value of the Voxel values that three-dimensionally surround the current calculation position X, or by any other method.

In step S4, the opacity α that corresponds to the interpolated Voxel value V is found from the interpolated Voxel value V that was found in step S3. The relationship between the opacity α and the Voxel value is as described above, however, by making the opacity around the Voxel value that corresponds to a site such as an organ that the user desires to view as an image equal to 1, it is possible for the user to clearly observe the desired site as an image.

The relationship between this interpolated Voxel value V and the opacity is calculated for each Voxel value using the piecewise function. Normally, in order to improve efficiency, a table of opacity values that correspond to interpolated Voxel values (Look Up Table (LUT)) is prepared in advance, and by referencing this table(LUT) it is possible to quickly find the opacity by extracting the opacity from the interpolated Voxel value. Hereafter, the function for finding the opacity will be call the opacity LUT.

In step S5, a color value C that corresponds to the interpolated Voxel value is obtained (the correlation between the Voxel value or interpolated Voxel value and the color or color value is called the color piecewise function, or the new color piecewise function). The color value C is formed from the hue, color saturation, and brightness (value), where one example of the color value C could be black and white. As another example, the values for the color saturation and brightness (value) could be set in advance, and only the hue is changed. Moreover, the color could be a fixed color. Hereafter, the function for finding this color value will be called the color LUT.

In step S6, the gradient G of the current calculation position X is found from the Voxel data (Voxel values) that surround the current calculation position X. The shading coefficient β is calculated from the calculated gradient G and the direction that the light travels (direction from the point where the light originates O to the current calculation position X). The shading coefficient β is calculated from the angle between the direction of travel of the light O-X and the gradient G (inner product). However, this is not limited to the inner product, and it is possible to set an arbitrary value as an arbitrary function for the direction of travel of light O-X and the gradient G.

In step S7, the damped light D and the partial reflected light F at the current calculation position X are calculated. The damped light D is the amount of light that indicates how much the incident light that corresponds to the remaining light I is reflected at the current calculation position X (how much light is damped with respect to the light that passes through the current calculation position X), and the damped light D is the value that is calculated by multiplying the remaining light I (light incident at the current calculation position) by the opacity ζ (Damped light D=Remaining light I×Opacity α).

Here, all of the damped light D does not necessarily become reflected light with respect to the direction of travel of the light O-X, and the ratio of the damped light that becomes reflected light with respect to the direction of travel of the light O-X is determined according to the shading coefficient β that was calculated for the current calculation position in step S6. Therefore, by taking the reflected light with respect to the direction of travel of the light O-X as being the partial reflected light F, the partial reflected light F becomes the value obtained by multiplying the product of the shading coefficient β and damped light D with the color value C, which is the ratio of color (Partial reflected light F=Shading coefficient β×Damped light D×Color value C).

In step S8, in order to perform the calculations in step S3 to step S7 at a position advancing just the calculated step ΔS in the direction of travel of light O-X, the reflected light E, remaining light I, and current calculation position X are updated. That is, the new reflected light E is taken to be E=E+F, the new remaining light I is taken to be I=I−D and the new current calculation position is taken to be X=X+ΔS.

In step S9, it is determined whether or not the current calculation position X is at a position where calculation has already been completed, or whether the remaining light I has become 0 (when the remaining light I becomes 0, there is no more light to advance further), and when it is determined that the current calculation position X is at a position where calculation has already been completed, or that the remaining light I has become 0 (step S9: YES), processing advances to step S10, however, when it is determined that the current calculation position X is not at a position where calculation has already been completed, or that the remaining light I has not become 0 (step S9: NO), processing advances to step S3.

In step S10, the reflected light E, which is the sum of the reflected light at all of the current calculation positions X is drawn as the pixel value of the pixel calculated at the projection origin point O (corresponding to picture elements on the screen).

### 5. First Embodiment

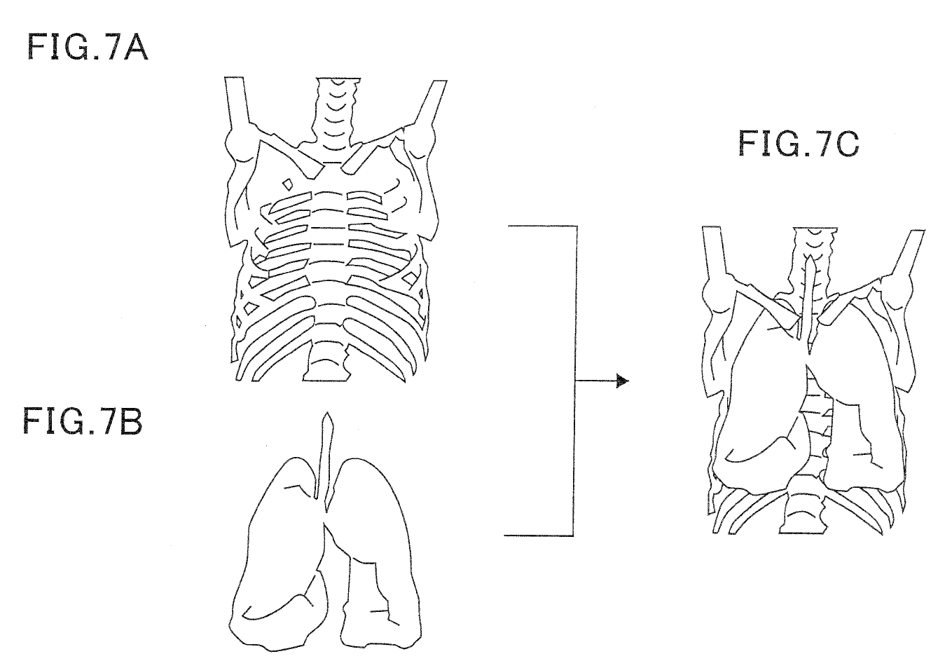

As a first embodiment of the invention, the case of dynamically creating color LUT tables that correspond to each organs when drawing by different opacity settings and different color settings such as hue, color saturation and brightness (value) for organs having different Voxel values such as CT values is explained. FIG. 7A is a drawing showing bones that are drawn from the Voxel data for a body using an opacity LUT that takes Voxel values expressing bone to be opaque. Moreover, FIG. 7B is a drawing showing the lungs from Voxel data of the body using an opacity LUT that takes the Voxel values expressing air (in lungs) to be opaque. The bones drawn in FIG. 7A and the lungs drawn in FIG. 7B are drawn as black and white images.

Here, by combining the two opacity LUTs described above, it is possible to draw the bones drawn in FIG. 7A and the lungs drawn in FIG. 7B simultaneously on one screen. In that case, conventionally, when an operator does not perform a special operation (operation using a human interface such as a mouse or keyboard), the bones and lungs are drawn simultaneously as a black and white site as drawn in FIG. 7C.

In FIG. 7C it is difficult to distinguish lung and bone (esp. at boundaries), where both are drawn in same color. Therefore, the display was inconvenient (display was not user friendly) for the user, who is a person related to medical treatment such as a doctor, or for the patient.

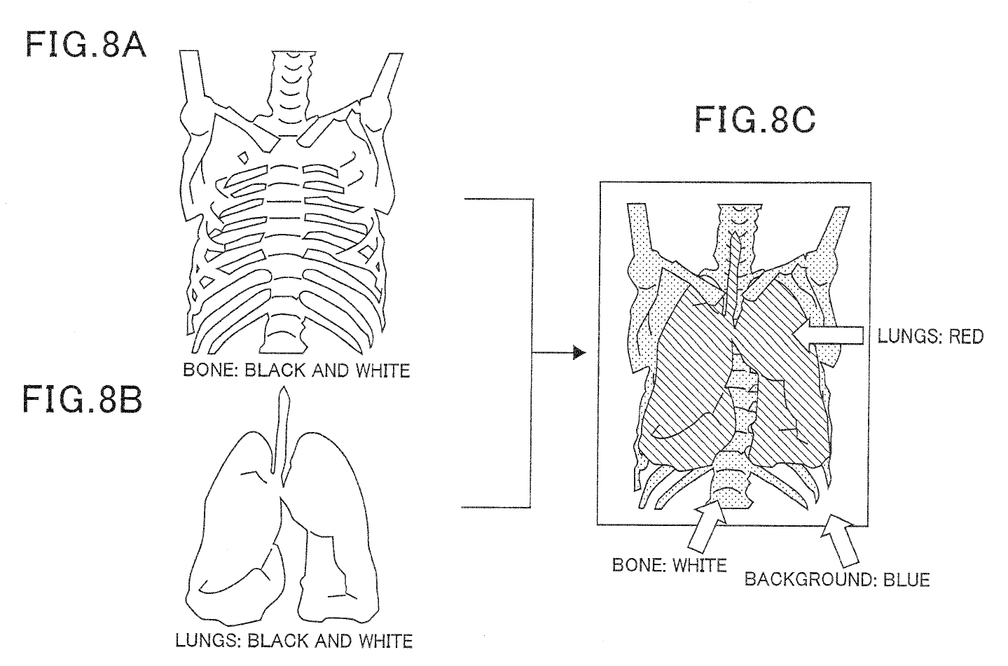

An example of a first embodiment of the present invention is shown in FIG. 8.

FIG. 8A is a drawing similar to FIG. 7A drawn in black and white showing bones around the ribcage that are drawn from the Voxel data for a body using an opacity LUT that takes Voxel values expressing bone to be opaque. In the case of observing just the bone around the ribcage, the user is able to sufficiently observe that site by drawing the image in black and white.

Moreover, FIG. 8B is a drawing similar to FIG. 7B drawn in black and white showing the lungs from Voxel data of the body using an opacity LUT that takes the Voxel values expressing air (lungs) to be opaque. In the case of observing just the lungs, the user is able to sufficiently observe that site by drawing the image in black and white.

In FIG. 8C, which shows a first embodiment of the invention in which the bone around the ribcage and the lungs are drawn (displayed) at the same time, each site is displayed such that the bone around the ribcage is displayed in white (color), the lungs are displayed in red (color), and the background color is changed to blue. The change in the display is made possible by creating a new color LUT in step 5 shown in FIG. 6 for each site to be displayed.

In FIG. 8 not only is the color of each of the drawn sites changed, but the background color is also changed. However, even if the background color is not changed, sites that are close to each other or overlapping can be easily identified by the red and white color, so it becomes easy for the user to identify each site.

### 5.1 Flowchart of the Operation of the First Embodiment

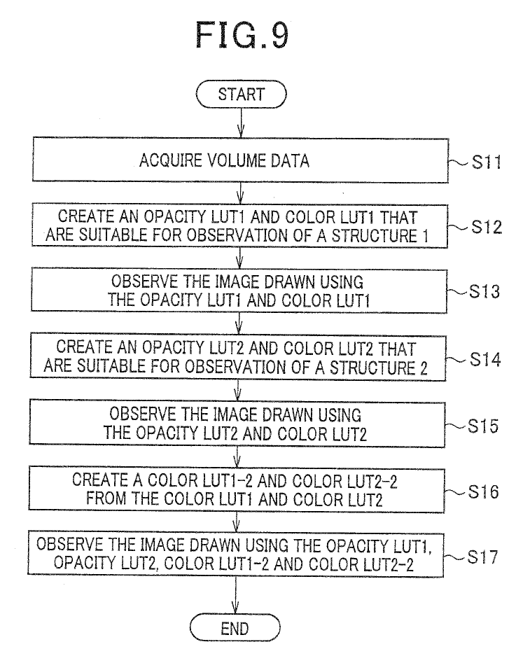

FIG. 9 is a flowchart showing the operation of the example of the embodiment shown in FIG. 8.

Each step of the flow of operations shown in FIG. 9 will be explained.

In step S11, the CPU 14 acquires volume data.

In step S12, the CPU 14 creates an opacity LUT1 that correlates the Voxel values suitable for observing structure 1 (for example, in FIG. 8 this is the bone around the ribcage) with opacity values (opacity), and creates a color LUT1 that correlates the Voxel values with color values.

In step S13, the CPU 14 uses the opacity LUT1 and color LUT1 that were created in step S12 from the Voxel values of structure 1 and draws (displays) the structure 1 on the monitor 4. The user views the structure 1 that is drawn on the monitor 4 as necessary when performing a medical procedure such as diagnosis or treatment.

In step S14, the CPU 14 creates an opacity LUT2 that correlates the Voxel values suitable for observing structure 2 (for example, in FIG. 8 this is the lungs) with opacity values (opacity), and creates a color LUT2 that correlates the Voxel values with color values.

In step S15, the CPU 14 uses the opacity LUT2 and color LUT2 that were created in step S12 from the Voxel values of structure 2 and draws (displays) structure 2 in a single image on the monitor 4. The user views the structure 2 that is drawn on the monitor 4 as necessary when performing a medical procedure such as diagnosis or treatment.

Next, the user operates a user interface such as the keyboard 5 or mouse 6, and gives a drawing instruction (display instruction) to the CPU 14 to draw both structure 1 and structure 2 on the monitor 4 at the same time.

After doing so, in step S16 the CPU 14 creates a new color LUT1-2 that corresponds to structure 1 and a new color LUT2-2 that corresponds to structure 2 in order that it be possible to clearly distinguish between structure 1 and structure 2 on the monitor 4. The color LUT1-2 and color LUT2-2 set the color so that at least one of the hue, color saturation or brightness (value) differs.

For example, with the color saturation and brightness the same, the CPU 14 assigns the white color LUT1-2 as the hue for structure 1 (bones around the ribcage in FIG. 8) and assigns the red color LUT2-2 as the hue for structure 2 (lungs).

In step S17, the CPU 14 uses the opacity LUT1 and color LUT1-2 for structure 1 and uses the opacity LUT2 and color LUT2-2 for structure 2, and draws and displays an image in a form by which structure 1 and structure 2 can be distinguished. The drawing method will be described later in detail using FIG. 12.

### 5-2. Method for Creating a Plurality of New Color LUTs

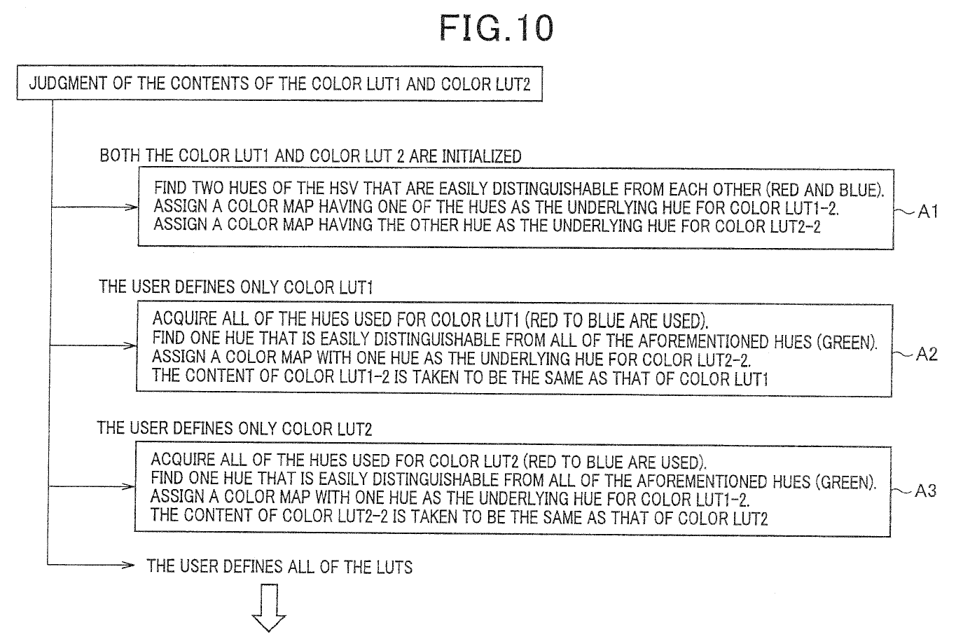

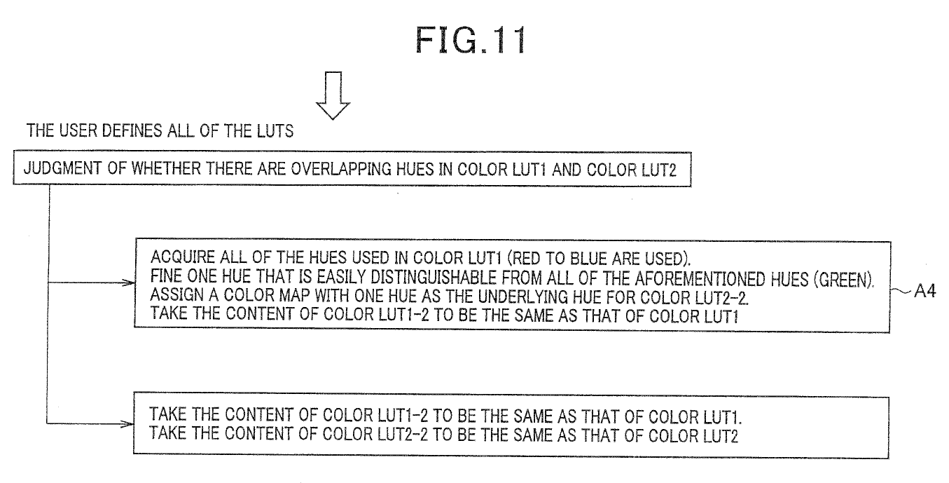

Next, FIG. 10 and FIG. 11 will be used to explain in detail the method for creating a color LUT in step 16 as part of the flow of operation of this embodiment.

The operation of this algorithm differs depending on whether or not the color LUT1 for structure 1 and color LUT2 for structure 2 are explicitly defined in advance by the user. This is because operations that are explicitly performed by the user have more weight.

First, the CPU 14 determines whether or not the user explicitly set the color LUT1 and color LUT2 in advance. When neither the color LUT1 nor the color LUT2 are a LUT set by the user, the CPU 14 executes the processing of A1.

In A1, the CPU 14 determines whether or not the colors of the picture elements that are drawn using the color LUT1 and color LUT2 can be easily distinguished from each other. The ease of distinction is evaluated by the hue, color saturation and brightness (value) of the color. When the colors of the picture elements that were drawn using the color LUT1 and color LUT2 cannot be easily distinguished, the CPU 14 selects red and blue, for example, as the colors of the picture elements to be drawn (red and blue are colors that are easily distinguishable from each other). The CPU 14 selects complementary colors, for example. Moreover, the CPU 14 changes the color LUT1 to a color LUT1-2 for which a color map that takes one color (for example, blue) to be the underlying color of the hue is assigned. The CPU 14 also changes the color LUT2 to a color LUT2-2 for which a color map that takes the other color (for example, red) to be the underlying color of the hue is assigned.

The CPU 14 uses the opacity LUT1 and color LUT1-2 for structure 1, and the opacity LUT2 and color LUT2-2 for structure 2 in this way to draw and display an image on the monitor 4.

Therefore, the user is able to clearly distinguish between the red color of the lungs and the blue color of the bone around the ribcage that are displayed at the same time on the monitor 4.

Next, the case in which only the color LUT1 is defined in advance by the user is explained (A2).

The CPU 14 obtains all of the hues that are used in the color LUT1 that is defined by the user. Moreover, the CPU 14 calculates another hue that is easily distinguished from all of the hues that are used in the color LUT1 using calculation such as a comparison operation. For example, in the case where the other easily distinguished hue is green, the CPU 14 changes the color LUT2 to a color LUT2-2 to which a color map is assigned that takes green to be the underlying hue.

The CPU14 also takes the contents of the color LUT1-2 to be the contents of the color LUT1 (that is the contents of the color LUT1-2 and color LUT1 are the same).

Therefore, the picture elements of the image that is drawn by the CPU 14 using the color LUT1-2 and color LUT2-2 are picture elements having green defined (selected) by the user in advance as the basis of the hue, and picture elements based on a hue that is easily distinguished from the calculated green, so the user is able to clearly distinguish between two structures (sites).

Next, the case in which only the color LUT2 is defined by the user in advance will be explained (A3).

The CPU 14 obtains all of the hues that are used in the color LUT2 that is defined in advance by the user. The CPU 14 also calculates another hue that is easily distinguished from all the hues used in the color table LUT2 using a calculation such as a comparison operation. For example, when the other hue that is easily distinguished is green, the CPU 14 changes the color LUT1 to a color LUT1-2 to which a color map is assigned that has green as the underlying hue.

The CPU 14 also takes the contents of the color LUT2-2 to be the contents of the color LUT2 (that is the contents of the color LUT2-2 and color LUT2 are the same).

Therefore, the picture elements of the image that is drawn by the CPU 14 using the color LUT1-2 and color LUT2-2 are picture elements having green defined (selected) by the user in advance as the basis of the hue, and picture elements based on a hue that is easily distinguished from the calculated green, so the user is able to clearly distinguish between two structures (sites).

Next, FIG. 11 will be used to explain the case in which the user defines both the color LUT1 and color LUT2 in advance.

First, the CPU 14 obtains all of the hues that are used in the color LUT1 and color LUT2 that are defined in advance by the user. The CPU 14 also determines whether or not all or part of the same hues are included in the color LUT1 and color LUT2. When all or part of the same hues are included, and when the CPU 14 displays different structures (sites) on the monitor using the color LUT1 and color LUT2, there is a high possibility that it will be difficult for the user to identify the different structures (sites), so one of the color LUTs must be changed.

In the explanation below, the case is explained in which the CPU 14 changes the color LUT2, however, as will be explained below, it is possible for the CPU 14 to change the color LUT1 and not change the color LUT2.

Next, the CPU 14 calculates another hue that is easily distinguished from all the hues that are used in the color LUT1 using calculation such as a comparison operation. For example, when the other easily distinguished hue is green, the CPU 14 changes the color LUT2 to a color LUT2-2 to which a color map that has green as the underlying hue is assigned (this does not reflect the contents of the color LUT2 that was set in advance by the user).

Moreover, the CPU 14 takes the contents of the color LUT1-2 to be the contents of the color LUT1 (the contents of the color LUT1-2 are the same as the contents of the color LUT1, and the contents of the color LUT1 that was set by the user in advance are reflected as it is).

The structures (sites) that are displayed by the CPU 14 with the picture elements of the image drawn using the color LUT1-2 and color LUT2-2 are displayed using picture elements having green that was defined (selected) in advance by the user as the basis for the hue, and picture elements based on a hue that is easily distinguished from the calculated green, so it is possible for the user to clearly distinguish between the two structures (sites).

### 6. Method of Drawing of the First Embodiment

FIG. 12 is a flowchart showing the drawing operation that includes the operation shown in FIG. 9 of the first embodiment of the invention. With this algorithm, rendering that uses a plurality of color LUTs for one group of volume data is possible.

Each of the steps of the flow of operation shown in FIG. 12 will be explained.

In step S20, the CPU 14 sets a projection origin point O for volume data V1 and sampling increment (calculation increment in the direction of travel of light from the projection origin point).

In step S21, the CPU 14 initializes the settings for the reflected light E, remaining light I and the current calculation position X. There is no reflected light at the projection origin point, so the reflected light E=0, also the light is not reduced at the projection origin point, so the remaining light is 1 (the value is normalized by 1). Moreover, the current calculation position X is taken to be the projection origin point, so the current calculation position X is initially set to X=0.

In step S22, taking the position at which calculation is to be performed for the first volume data V1 from the projection origin point as the current calculation position X, the CPU 14 finds the interpolated Voxel value at the current calculation position X from the surrounding Voxel data (surrounding Voxel values). This is because the current calculation position X is not always at the grid shaped vortices obtained from CT or the like.

The CPU 14 also finds the gradient g at the current calculation position X from the Voxel data (Voxel values) surrounding the current calculation position X.

In step S23, the CPU 14 calculates the opacity α1 and color value C1 that corresponds to the structure (site) 1 at the current calculation position X from the opacity LUT1 that was calculated in advance from the interpolated Voxel value V that was calculated in step S22 (the opacity LUT1 is set in advance from the volume data V1 when structure (site) 1 is displayed alone (as an example is the case shown in FIG. 8A of displaying the bone around the ribcage alone)), and from the color LUT1-2 that was explained using FIG. 9 to FIG. 11.

In step S24, the CPU 14 calculates the opacity α2 and color value C2 that corresponds to the structure (site) 2 at the current calculation position X from the opacity LUT2 that was calculated in advance from the interpolated Voxel value V that was calculated in step S22 (the opacity LUT2 is set in advance from the volume data V1 when structure (site) 2 is displayed alone (as an example is the case shown in FIG. 8B of displaying the lungs alone)), and from the color LUT2-2 that was calculated in advance as explained using FIG. 9 to FIG. 11.

In step S25, the CPU 14 calculates the shading coefficient β from the gradient g that was calculated in step S22.

In step S26, the CPU 14 calculates a new opacity α for the current calculation position X from the opacity α1 that was calculated in step S23, and the opacity α2 that was calculated in step S24, in the case when the structure (site) 1 and structure (site) 2 are to be displayed at the same time. The value of the new opacity α is taken to be the larger of the values for opacity α1 and opacity α2.

In the other words, when opacity α1>α2, the new opacity α=opacity α1, when opacity α1<opacity α2, the new opacity α=opacity α2, and when opacity α1=opacity α2, the new opacity α=opacity α1=opacity α2.

Furthermore, the CPU 14 calculates a new color value C for the current calculation position X from the opacity α1 and color value C1 that were calculated in step S23, and the opacity α2 and color value C2 that were calculated in step S24, when displaying structure (site) 1 and structure (site) 2 at the same time (the color value C is calculated from Equation 1 for example).

C=(α1×C1+α2×C2)/(α1+α2) Equation 1

In step S27, the CPU 14 calculates the damped light D and the partial reflected light F at the current calculation position X, and updates the reflected light E and remaining light I in order to perform the calculations from step S22 to step S26 at a new position located just the sampling increment ΔS further in the direction of travel of the light O-X.

Here, the damped light D is the amount of light that indicates how much of the incident light that corresponds to the remaining light I is reflected at the current calculation position X (how much light is damped with respect to the light that passes the current calculation position X), so the damped light D become the value obtained by multiplying the remaining light I (incident light at the current calculation position X) by the opacity α (Damped light D=Remaining light I×Opacity α).

Not all of the damped light D becomes light that returns with respect to the direction of travel of the light O-X, and the ratio of the damped light that becomes reflected light with respect to the direction of travel of the light O-X is determined according to the shading coefficient β at the current calculation position that was calculated in step S25. Therefore, by taking the light that returns with respect to the direction of travel of the light O-X to be the partial reflected light F, the partial reflected light F becomes the value obtained by multiplying the product of the shading coefficient β and the damped light D with the color value C, which is the color ratio (Partial reflected light F=Shading coefficient β×Damped light D×Color value C).

Furthermore, the new reflected light is set to E=E+F, and the new remaining light is set to I=I−D.

In step S28, the CPU 14 updates the current calculation position by just the amount of the sampling increment ΔS. In other words, the CPU 14 sets the current calculation position as X=X+ΔS.

In step S29, the CPU 14 determines whether the current calculation position is a position for which calculation has already been completed, or whether the remaining light I has become ‘0’ (when the remaining light I becomes 0, there is no more light to advance further), and when the current calculation position is not a position for which calculation has already been completed, or when the remaining light I is not ‘0’ (step S29: NO), the CPU 14 proceeds to step S22, however, when the current calculation position is a position for which calculation has already been completed, or when the remaining light I has become ‘0’ (step S29: YES), the CPU 14 proceeds to step S30.

In step S30, the reflected light E, which is the sum of reflected light at all of the current calculation positions X, is drawn as the pixel value of the pixel calculated at the projection origin point O (corresponds to a picture element on the screen).

By doing this and creating a new color LUT, it is possible to distinguish and draw a plurality of images, when there is a plurality of objects to be observed. Particularly, when there are ranges of the opaque portions of the opacity LUT that overlap when expressing each object to be observed, by using a plurality of color LUTs, it is possible to distinguish and draw a plurality of objects to be observed without having to perform complicated settings for a single color LUT. Moreover, it is possible to quickly reflect changes to the opacity LUT and color LUT of any one of the objects to be observed on the image that displays the plurality of objects to be observed.

### 7. Second Embodiment

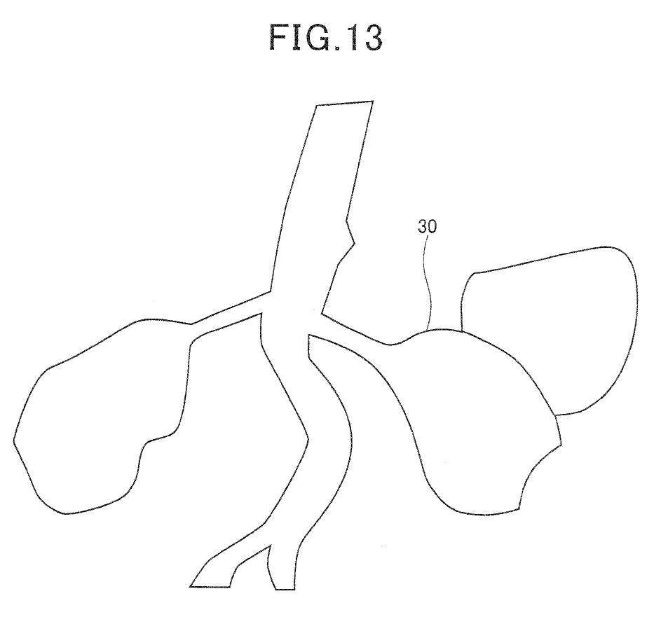

As a second embodiment of the invention, FIG. 13 to FIG. 16 will be used to explain. This embodiment is a case of dynamically creating color LUTs corresponding to various organs. When two regions are extracted using an organ extraction algorithm of organs having same (or over lapping) Voxel values. The two regions shall be drawn distinguished by setting opacity settings and color settings such as hue, saturation and brightness (value) for each region to be drawn.

FIG. 13 is a drawing of a display on the monitor 4 of the outline of the kidneys and blood vessels 30 that connect to the kidneys obtained by extracting regions from volume data of a human body using an organ extraction algorithm and using a black and white (or color) image.

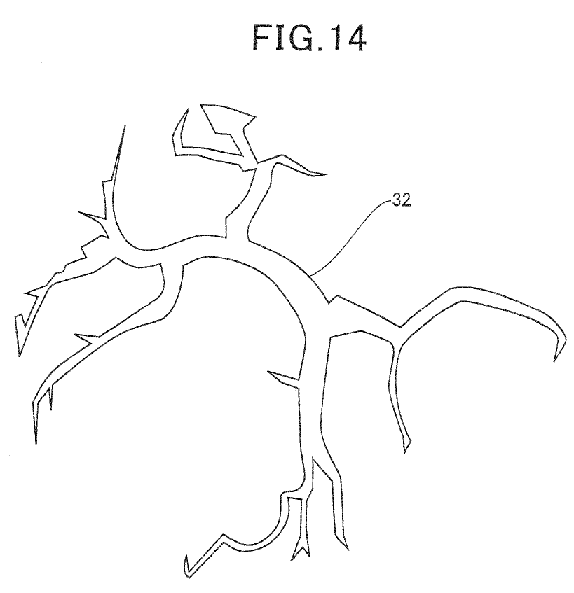

FIG. 14 is a drawing of a display on the monitor 4 of the outline of large blood vessels 32 around the kidneys and liver obtained by extracting regions from volume data of a human body using an organ extraction algorithm and using a black and white (or the same color as in FIG. 13 (this means the hue, saturation and value are the same)) image.

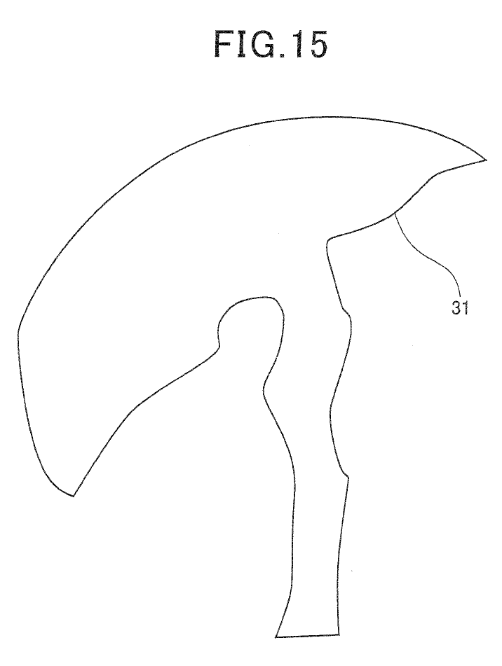

FIG. 15 is a drawing of a display on the monitor 4 of the outline of the liver and blood vessels 31 that connect to the liver obtained by extracting regions from volume data of a human body using an organ extraction algorithm and using a black and white (or the same color as in FIG. 13 (this means the hue, saturation and value are the same)) image.

The reason for extracting regions using an organ extraction algorithm is because the kidneys and blood vessels 30 that connect to the kidneys, the liver and blood vessels 31 that connect to the liver, and the thick blood vessels 32 around the kidney and liver have CT values that are close to each other, so it is not possible to make a simple distinction by using just the CT values. Therefore, regions are extracted using an organ extraction algorithm to obtain the regions of each structure. Moreover, the acquired region is taken to be a mask, and by drawing only the masked region, and image of each structure is created.

When displaying the outline of the kidneys and the blood vessels 30 that connect to the kidneys, the outline of the liver and the blood vessels 31 that connect to the liver and the outline of the thick blood vessels 32 around the kidneys and the liver at the same time using a black and white (or the same color (means the hue, saturation, and value are the same)) image, it is difficult for the user to distinguish between the outline of kidneys and the blood vessels 30 that connect to the kidneys, between the outline of the liver and the blood vessels 31 that connect to the liver, and between the outline of the thick blood vessels 32 around the kidneys and out line of the liver, from each other.

Moreover, it is difficult for the user to recognize the relationship (includes the relationship of which portion is in front or behind as seen from the point of sight) between the blood vessels 30 that connect to the kidneys, the outline of the liver and the blood vessels 31 that connect to the liver and the outline of the thick blood vessels 32 around the kidneys and the liver, and thus it may be difficult for the user to perform suitable medical treatment, or due to the complex operation that must be performed in order to improve recognizability of the image, it may become difficult for the user to smoothly and accurately perform medical treatment.

On the other hand, since each structures have CT values that are close, it is not possible to distinguish and draw the structures using only one color LUT.

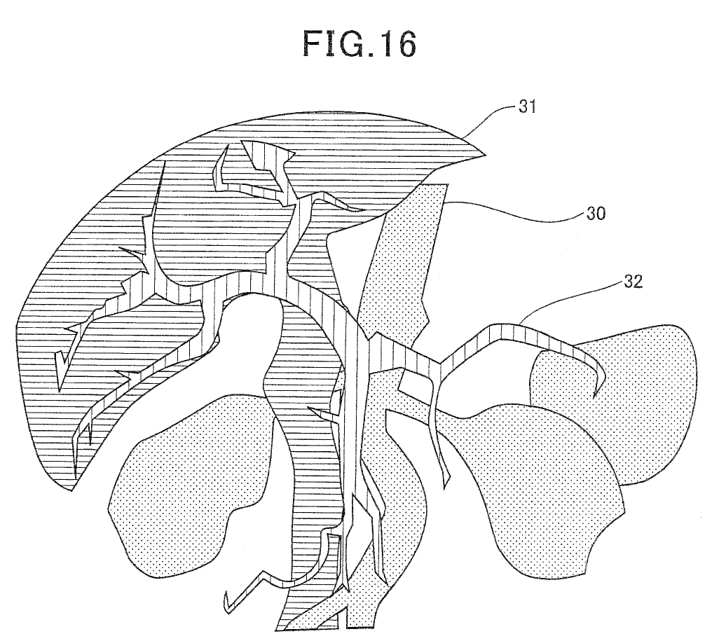

However, as shown in FIG. 16, when the outline of the kidneys and blood vessels 30 that connect to the kidneys, the outline of the liver and blood vessels 31 that connect to the liver and the outline of the large blood vessels 32 that are around the kidneys and liver are displayed at the same time so that at least one of the hue, saturation and value are different (it is preferred that each site be displayed at the same time with the underlying hues being different from each other), the user is easily able to distinguish and recognize the kidneys and blood vessels 30 that connect to the kidneys, the liver and blood vessels 31 that connect to the liver and the large blood vessels 32 that are around the kidneys and liver, and it becomes possible for the user to easily recognize the spatial positional relationship in the body of the kidneys and blood vessels 30 that connect to the kidneys, the liver and blood vessels 31 that connect to the liver and the large blood vessels 32 that are around the kidneys and liver (it becomes possible to easily recognize the front and behind relationship of each site from the point of sight).

Moreover, in this second embodiment, the case was explained of displaying the outlines of the kidneys and blood vessels 30 that connect to the kidneys, the liver and blood vessels 31 that connect to the liver and the large blood vessels 32 that are around the kidneys and liver, however, the invention is not limited to this, and for example, it is possible to use the shapes of the kidneys and blood vessels 30 that connect to the kidneys, the liver and blood vessels 31 that connect to the liver and the large blood vessels 32 that are around the kidneys and liver as masks to display sites (structures) on the inside of portions that are surrounded by the kidneys and blood vessels 30 that connect to the kidneys, the liver and blood vessels 31 that connect to the liver and the large blood vessels 32 that are around the kidneys and liver at the same time.

Raycast method using a mask (region of each structure that has been extracted) to draw shall be explained. When the position X is not included in the mask (not included in the region of structure), finding the opacities α1, α2 in steps S23, S24 of the algorithm shown in FIG. 12, opacity not included in the mask shall be ‘0’. Mask can be given for each structure and Raycast method using plurality of masks is possible. It can be implemented by rendering voxel selecting LUT which corresponding for each mask. If a voxel is included in 2 masks, each result (opacity, color) of corresponding 2 LUT may be synthesized.

By doing this it is possible to draw images without the user having to explicitly create a plurality of color LUTs even when it is not possible to distinguish and draw a structure with one single color LUT.

### 8. Other Embodiments

The case of displaying two structures (sites) or three structures (sites) at the same time was explained using FIG. 9 or FIG. 16, however, there is no limit to the number of structures (sites) that can be displayed at the same time, and it is possible to display any arbitrary number of structures (sites) at the same time, and color LUTs are created that correspond to each structures (sites).

In FIG. 9, the explanation ended with the state in which two structures (sites) are displayed at the same time, however, in the present invention, when displaying each structure (site) separately again after displaying the two structures (sites) at the same time, it is possible to continue to use the newly created color LUT1-2 and color LUT2-2.

In FIG. 9, the explanation ended with the state in which two structures (sites) are displayed at the same time, however, in the present invention, when displaying each structure (site) separately again after displaying the two structures (sites) at the same time, when the user desires to use the color LUT1 and color LUT2 that were used when displaying each structure (site) separately instead of continuing to use the newly created color LUT1-2 and color LUT2-2, it is possible to use the color LUT1 and color LUT2. By doing so, it is possible to draw images with good observability when observing each structure separately, and to simply drawing images with good distinguishability when observing two structures at the same time.

Moreover, in FIG. 9 the color LUT1-2 is set so that it is different from the color LUT1, however, the color LUT1-2 and color LUT 1 can be the same. Or, it is also possible for the color LUT2-2 to be the same as the color LUT2.

The color of each of the structures (sites) was set using a LUT, however, the invention is not limited to this, and it is possible to set the color of each of the structures (sites) using another method such as an arbitrary function.

Moreover, the color of each structure (site) is set using a LUT, however, the invention is not limited to this, and it is possible for the color of each structure (site) to be a fixed color. This is because, in this invention, a color is set for each structure, so it is not necessary to set the color according to the Voxel value. In this case, the process of converting the color LUT is eliminated, so it is possible to improve the drawing speed.

When creating a new color LUT, it is possible to set a plurality of hues for one color LUT, and to display a plurality of structures (sites) using at least one or more color LUTs that include a plurality of hues. In FIG. 12, an algorithm for a typical Raycast method is shown, however, various forms of the Raycast method are possible, such as a form in which the gradient G is not used, a form of parallel execution, a form of using fixed color values instead of using a color LUT, a form of setting a sub light source, or a form of drawing using a perspective projection method. In other words, the Raycast method can be any method of using the opacity of the Voxels, and the setting the picture elements of an image using the reflected light from the volume data.

Moreover, in FIG. 12, as an algorithm for a typical Raycast method, the opacity values of the Voxels are calculated from the Voxel values, however, it is possible to assign opacity values to the Voxels in advance. That is because it is one masking method.

The operating procedure shown in FIG. 6 and FIG. 9 to FIG. 12 can be recorded in advance on a recording medium such as a hard disk, or can be recorded in advance via a network such as the Internet; and by reading and executing this procedure by a general-purpose microcomputer or the like, it is possible for that general-purpose microcomputer to function as the CPU in the embodiments.

What is claimed is:

1. A medical image display device that visualizes at least one volume data using a Raycast method, comprising:
a color acquisition function for acquiring color from voxel value, wherein at least two or more color acquisition functions are corresponding to at least one of the volume data;
a color acquisition function calculating feature for calculating a new color acquisition function that corresponds to at least one of the color acquisition functions; and
a visualization feature for visualizing the at least one volume data by the Raycast method using two or more color acquisition functions and, at least one of the color acquisition function is the new color acquisition function.

2. The medical image display device of claim 1, wherein
the color acquisition function calculating feature performs calculation so that the new color acquisition function to differ from other color acquisition functions so that at least one of hue, saturation and value of the color assigned by the color acquisition functions differs from each other, when the colors assigned by the two or more color acquisition functions are similar to each other.

3. The medical image display device of claim 1, wherein
the color acquisition function calculating feature calculates the new color acquisition function that correspond to other color acquisition functions that are not set in advance by a user in the case when there are the color acquisition functions that are set in advance by the user.

4. The medical image display device of claim 3, wherein
the color acquisition function calculating feature performs calculation so that the new color acquisition function to differ from the color acquisition functions that are set in advance by the user, so that at least one of the hue, saturation and value of the color assigned by the color acquisition functions differ from each other.

5. The medical image display device of claim 1, further comprising:
a mask acquisition feature for acquiring masks that correspond to each of the color acquisition functions; wherein
the visualization feature uses the masks to visualize the at least one volume data by the Raycast method.

6. The medical image display device of claim 1, wherein
the color acquisition function is implemented by a piecewise function.

7. The medical image display device of claim 6, wherein the piecewise function of the color acquisition function is implemented by a Look Up Table (LUT).

8. A control method for a medical image display device that visualizes at least one group of volume data using a Raycast method, comprising:
a color acquisition function for acquiring color from voxel value, wherein at least two or more color acquisition functions are corresponding to at least one of the volume data;
a color acquisition function calculation step of calculating a new color acquisition function that corresponds to at least one of the color acquisition functions; and
a visualization step of visualizing the at least one group of volume data by the Raycast method using two or more color acquisition functions and, at least one of the color acquisition function is the new color acquisition functions.

9. The control method for a medical image display device of claim 8, wherein
the color acquisition function calculation step performs calculation so that the new color acquisition function to differ from other color acquisition functions so that at least one of hue, saturation and value of the color assigned by the color acquisition functions differs from each other, when the colors assigned by the two or more color acquisition functions are similar to each other.

10. The control method for a medical image display device of claim 8, wherein
the color acquisition function calculation step calculates the new color acquisition functions that correspond to other color acquisition functions that are not set in advance by a user in the case when there are the color acquisition functions that are set in advance by the user.

11. The control method for a medical image display device of claim 10, wherein
the color acquisition function calculation step performs calculation so that the new color acquisition function to differ from the color acquisition functions that are set in advance by the user, so that at least one of the hue, saturation and value of the color assigned by the color acquisition functions differ from each other.

12. The control method for a medical image display device of claim 8, further comprising:
a mask acquisition step of acquiring masks that correspond to each of the color acquisition functions; wherein
the visualization step uses the masks to visualize the at least one volume data by the Raycast method.

13. The control method for a medical image display device of claim 8, wherein
the color acquisition function is implemented by a piecewise function.

14. The control method for a medical image display device of claim 13, wherein
the piecewise function of the color acquisition function is implemented by a Look Up Table (LUT).
